(19) United States
(12) Patent Application Publication
(10) Pub. No.: US 2002/0077874 A1
(43) Pub. Date: Jun. 20, 2002

(54) Methods and systems for time sharing on cruise ships

(76) Inventor: Rollin N. Dakin, Bethel, CT (US)

Correspondence Address: John S. Beulick, Armstrong Teasdale LLP, Suite 2600, One Metropolitan Square, St. Louis, MO, 63102-2740, US

(21) Appl. No.: 09/737,702

(22) Filed: Dec. 15, 2000

(51) Int. Cl. G06F 17/60

(52) U.S. Cl. 705/8

(57) ABSTRACT

A method for implementing a time sharing arrangement for cabins on a cruise ship is disclosed. The method is implemented on a system configured for management of timeshares. The method includes the steps of uploading a designation of certain blocks of cabins on at least one ship as being for sale as timeshare cabins, uploading a designation of terms and conditions for the sale of a timeshare unit and closing the transaction with a customer.

### BACKGROUND OF THE INVENTION

This invention relates generally to timeshare units, and, more specifically to, methods and systems for purchasing timeshare units.

It is well known, especially in desirable locations, for condominiums and resort hotels to designate units, rooms and suites for timeshare. Timesharing typically provides vacationers an upscale vacation location, for a set period of time. The time share unit provides certain amenities the typical hotel does not provide. For example, many time share condominium units include garage parking, kitchen facilities, and multiple rooms, for relaxation and entertainment, over and above the simple sleeping room which most hotels and motels offer. Even hotels and motels which offer upscale amenities, such as swimming pools, gyms, and the like, the vacationers must still share and compete for the use of such amenities with other guests. Many timeshare facilities also have such amenities, and during the time unit that the timeshare purchaser has purchased, the timeshare purchaser has the luxury of not having to share those amenities, which is the case with the typical hotel guest.

In would be desirable to utilize the time share concept for multiple types of facilities. In addition, it would be desirable to provide a method for potential purchasers to learn about such timeshare offerings and to provide timeshare purchasers with financing for the purchase.

### BRIEF SUMMARY OF THE INVENTION

A method for implementing a time sharing arrangement for cabins on a cruise ship includes uploading a designation of certain blocks of cabins on at least one ship as being for sale as timeshare cabins. In addition, a designation of terms and conditions for the sale of a timeshare unit is uploaded. Finally, the transaction is closed with the customer. The method described above is, in one embodiment, implemented on a system configured for management of timeshares which includes a server and at least one computer connected to the server through a network, for example, the Internet.

### BRIEF DESCRIPTION OF THE DRAWINGS

FIG. 1 is a system diagram; and

FIG. 2 is a flowchart showing a method for selling timeshares to cabins on cruise ships.

### DETAILED DESCRIPTION OF THE INVENTION

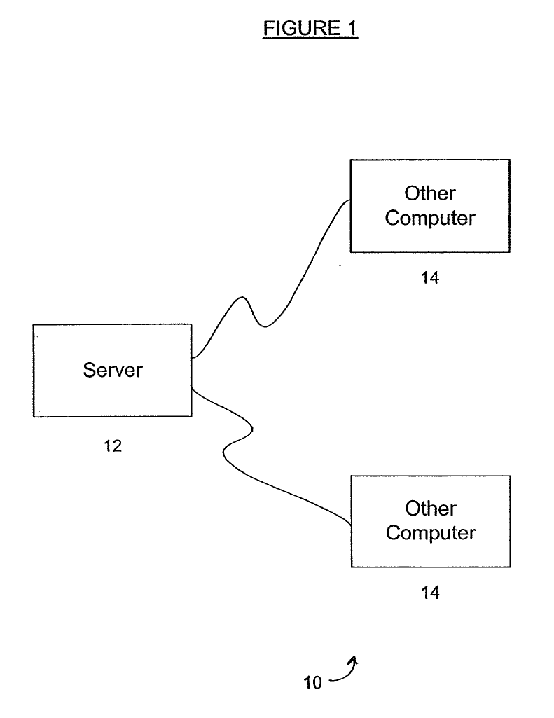

FIG. 1 illustrates an exemplary system 10 in accordance with one embodiment of the present invention. System 10 includes a computer configured as a server 12 and a plurality of other computers 14 coupled to server 12 to form a network. The network of computers may be a local area network (LAN) or a wide area network (WAN).

Server 12 is configured to receive and store information relating to the reservations and time sharing of cabins on cruise ships within one or more databases. One database included within server 12 acts as a shell for a time sharing system and contains configuration documents, a home page, and links to other applications. The shell database serves to keep the time sharing application modular thereby allowing new applications to be plugged into the time sharing application.

In one embodiment, server 12 is coupled to computers 14 via a WAN or LAN. In alternative embodiments, a user may dial in or directly login to an Intranet or the Internet to gain access to server 12. Each computer 14 includes an interface for communicating with server 12. The interface facilitates user input of data relating to time sharing and also the reception of information output. A computer-based time sharing tool, as described below in more detail and including the database described above, is stored in server computer 12 and can be accessed by a requester at any one of computers 14. A system such as system 10 provides anytime, anyplace access to time sharing information, stored in the databases, required by, for example, reservation personnel and timeshare owners. In one embodiment, the databases are accessible from an Intranet or Internet web page.

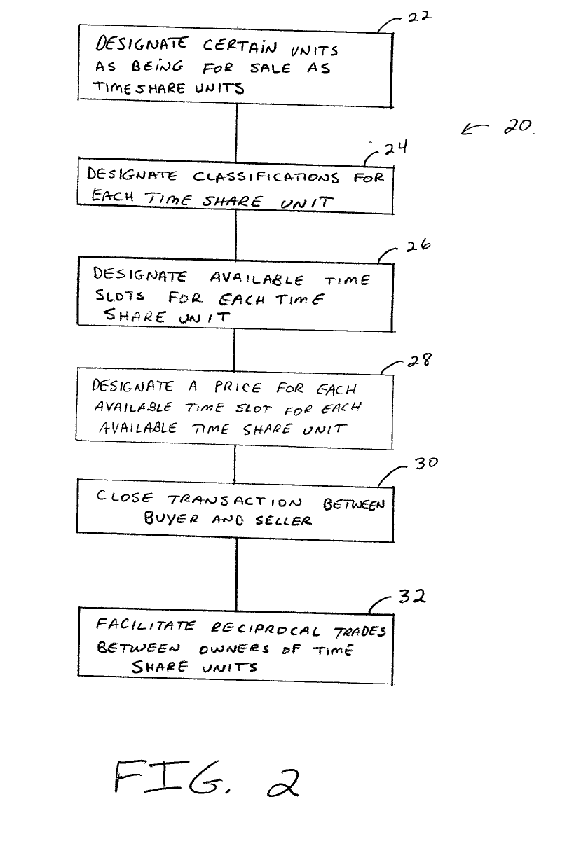

FIG. 2 is flowchart 20 showing a method for selling timeshares to cabins on cruise ships. As shown in flowchart 20, the method includes designating 22 certain blocks of cabins on at least one ship, for the cruise line, as being for sale as timeshare cabins. After the cabins are designated 22, terms and conditions for the sale of each timeshare unit are set.

The method, in one embodiment, includes a designation 24 of a classification for each unit available for time share purchase. Each unit available for purchase as a timeshare unit is classified, for example, by one of suite, first class, an interior (no window) cabin, and an exterior cabin. Also which floor of the cruise ship the cabins are located are of interest to a potential timeshare purchaser.

Since by its nature a timeshare is a purchase of a unit of time, and since cruises are typically one or two weeks, although exceptions apply, a potential timeshare purchaser would need to know which time slots are available for the timeshare units, and what the duration is for those time slots. Therefore, in one embodiment includes the designating 26 of which weeks, or other units of time, are available for the timeshare units.

There are peak time of the calendar year for taking cruises and vacationing, depending upon the geographic location of the cruise or vacation site. Peak vacation times on cruises sell quickly, while during slower times of the year, cabins go unoccupied. Still another embodiment includes the designation 28 of a sales price, which would be typically commensurate with demand for cabin space, for each timeshare unit available for each time slot for each cabin.

The method is completed by closing 30 the sale of a particular time share unit with a customer.

After a timeshare sale has closed, it is possible that a purchaser of a timeshare unit on a cruise ship could become unavailable for the time slot that has been purchased. In one embodiment, system 10 (shown in FIG. 1) is configured to present to a timeshare owner possible reciprocal trades of timeshare cabins on other ships within the database, either of the same cruise line or another cruise line. System 10 is further configured to facilitate 32 such reciprocal trades, since it is quite likely that other timeshare owners will find themselves also unavailable, and are looking to trade or sell their purchased timeshares. In another embodiment, system 10 is configured to facilitate a trade between an owner of an unusable timeshare unit, because of a time conflict, for example, and the party that is selling time shares, such that the owner of the time share unit can trade for an as of yet unpurchased timeshare time slot.

In yet another embodiment, the database and system 10 referred to is maintained by a company that is positioned to provide financing to potential customers for a timeshare purchase or financing to a cruise line for construction of a ship where timeshares have been presold.

Although the systems and methods described above are described in terms of providing timeshare purchases of cruise ship cabins, the systems and methods should not be construed as being so limited. It is contemplated that such systems and methods be implemented for other time share purchases, several examples include, but are not limited to, airline seats, bus and rail seats, boats, yachts, airplanes and other vehicles which are located at certain destinations. In addition, system 10, is configurable to display for potential purchasers of time share units, photographs of the time share units as the potential purchaser browses the database of available time share units.

While the invention has been described in terms of various specific embodiments, those skilled in the art will recognize that the invention can be practiced with modification within the spirit and scope of the claims.

What is claimed is:

1. A method for implementing a time sharing arrangement for cabins on a cruise, said method comprising the steps of:
designating certain blocks of cabins on at least one ship as being for sale as timeshare cabins;
setting terms and conditions for the sale of a timeshare unit; and
closing the transaction with a customer.

2. A method according to claim 1 wherein said step of setting terms and conditions further comprises the step of setting a timeshare duration for each unit.

3. A method according to claim 1 wherein said step of setting terms and conditions further comprises the step of classifying each cabin.

4. A method according to claim 1 wherein said step of terms and conditions further comprises the step of showing available dates for the timeshare unit.

5. A method according to claim 1 wherein said step of setting terms and conditions further comprises the step of setting a sales price for each timeshare unit available for each cabin.

6. A method according to claim 1 further comprising the step of implementing reciprocal trades of timeshare cabins on other ships either within the cruise line or cruise ships of another cruise line.

7. A method according to claim 1 wherein said step of closing the transaction with a customer further comprises the step of providing financing to the customer for the timeshare purchase.

8. A method for implementing a time sharing arrangement for cabins on a cruise ship using a system configured for management of timeshares, said method comprising the steps of:
uploading a designation of certain blocks of cabins on at least one ship as being for sale as timeshare cabins;
uploading a designation of terms and conditions for the sale of a timeshare unit; and
closing the transaction with a customer.

9. A method according to claim 8 wherein said step of uploading a designation of terms and conditions further comprises the step of uploading a timeshare duration for each unit.

10. A method according to claim 8 wherein said step of uploading a designation of terms and conditions further comprises the step of uploading a classification of each cabin.

11. A method according to claim 8 wherein said step of uploading a designation of terms and conditions further comprises the step of uploading dates showing availability of the timeshare unit.

12. A method according to claim 8 wherein said step of uploading a designation of terms and conditions further comprises the step of uploading a sales price for each time unit available for each cabin.

13. A method according to claim 8 further comprising the step of browsing the database for possible reciprocal trades of timeshare cabins on other ships within the database.

14. A method according to claim 8 wherein said step of closing the transaction with a customer further comprises the step of providing financing to the customer for the timeshare purchase.

15. A system for implementing a time sharing arrangement for cabins on a cruise ship, said system configured for management of timeshares and comprising:
at least one computer;
a server configured to upload and store within a database at least one of a designation of certain blocks of cabins on at least one ship as being for sale as timeshare cabins, a designation of terms and conditions for the sale of a timeshare unit and a closing of the transaction with a customer; and
a network interconnecting said server to said at least one computer.

16. A system according to claim 15 wherein said server is configured to upload and store a timeshare duration for each unit.

17. A system according to claim 15 wherein said server is configured to upload and store a classification of each cabin.

18. A system according to claim 15 wherein said server is configured to upload and store dates showing availability of the timeshare unit.

19. A system according to claim 15 wherein said server is configured to upload and store within said database a sales price for each timeshare unit available for each cabin.

20. A system according to claim 15 wherein said server is configured to browse said database for possible reciprocal trades of timeshare cabins on other ships within said database.

21. A system according to claim 15 wherein said server is further configured to facilitate the financing of the timeshare purchase.
